(19) United States
(12) Patent Application Publication
(10) Pub. No.: US 2011/0297096 A1
(43) Pub. Date: Dec. 8, 2011

(54) LITTER BOX WITH REMOVABLE FILTER HOUSING

(75) Inventors: Melaney Northrop, Mansfield, TX (US); Adam Weber, Keller, TX (US); David Veness, Fort Worth, TX (US); Mark Kitchens, Athens, TX (US); Regis Wandres, Athens, TX (US)

(73) Assignee: DOSKOCIL MANUFACTURING COMPANY, INC., Arlington, TX (US)

(21) Appl. No.: 13/021,397

(22) Filed: Feb. 4, 2011

Related U.S. Application Data
(60) Provisional application No. 61/301,514, filed on Feb. 4, 2010.
(60) Provisional application No. 61/377,073, filed on Aug. 25, 2010.

(51) Int. Cl. A01K 29/00

(52) U.S. Cl. 119/165; 119/161

(57) ABSTRACT

A litter box for an animal. The litter box includes a base portion, a cover portion operably connected to the base portion and a removable housing operably connected to one of the cover portion and the base portion. The base portion includes a floor and a plurality of walls extending in an upward direction from the floor. The cover portion includes a ceiling and a plurality of walls extending in a downward direction from the ceiling. The housing is configured to receive an operating element. Also, one of the cover portion and the base portion is configured to receive the removable housing.

### CROSS-REFERENCE TO RELATED APPLICATIONS

This application claims priority, pursuant to 35 U.S.C. §119(e), of U.S. provisional application No. 61/301,514, filed Feb. 4, 2010 entitled “Litter Box with Removable Filter Housing;” and U.S. provisional application No. 61/377,073, filed Aug. 25, 2010 entitled “Litter Box with Removable Housing,” which are hereby incorporated herein as if set forth in their entireties.

### TECHNICAL FIELD

Embodiments described herein relate to an animal litter box, and, more particularly, to an animal litter box having a removable housing.

### BACKGROUND ART

The use of filters in covered animal litter boxes has become increasingly popular. The cover conceals the animal waste and soiled litter from view and affords the animal privacy while using the litter box. The filter is typically replaceable and serves to absorb and/or neutralize litter box odors. When the filter loses its capacity to absorb odors, the pet owner removes and replace the filter.

Existing litter boxes sometimes include a filter receptacle integrated with the litter box housing. For example, the filter receptacle may be provided on the ceiling or along the rear end of the litter box cover. A typical filter receptacle may include a receiving portion molded into the litter box cover and configured to receive the filter, as well as a filter cover plate that is removable and/or connected to the litter box cover via a hinge. However, litter box covers including an integral filter receptacle may be difficult and/or costly to manufacture. Further, if the either the cover plate or the receiving portion of the filter receptacle is damaged or broken, the entire litter box is often replaced.

### SUMMARY

One embodiment may take the form of a litter box including a base portion having a floor and a plurality of walls extending in an upward direction from the floor. The litter box may also have a cover portion having a ceiling and a plurality of walls extending in a downward direction from the ceiling. The litter box may further have a removable filter housing configured to receive a filter member. One of the cover portion and the base portion is configured to receive the removable filter housing.

Another embodiment takes the form of a litter box including a filter configured to deposit a deodorizer onto an inner surface of the litter box. The filter includes a filter cover and a filter base operably connected to the filtering cover. A storage cavity is defined by the connection between the filter cover and the filter base, the storage cavity is configured to hold the deodorizer. A motor is operably connected to the filter base and a dispensing plate is operably connected to the storage cavity and is in communication with the motor.

Still other embodiments take the form of a method for manufacturing a litter box. The method may include forming a litter box portion including a floor and a plurality of walls that extend in a generally upward direction from the floor, forming a cover portion including a ceiling and a plurality of walls that extend in a generally downward direction from the ceiling, and forming a filter housing separate from the litter box portion and the cover portion. The filter housing includes an opening configured to receive a filter member, and the cover portion includes a receiving portion configured to receive the filter housing.

These and other objects and advantages of the disclosed embodiments will become readily apparent from the following detailed description taken in conjunction with the accompanying drawings.

### BRIEF DESCRIPTION OF THE FIGURES

FIG. 1A illustrates a front perspective view of a first embodiment of a covered animal litter box employing a removable filter housing.

FIG. 1B illustrates a rear perspective view of the embodiment of FIG. 1A.

FIG. 1C illustrates a partial rear perspective view of the embodiment of FIG. 1A with the removable filter housing removed.

FIG. 2A illustrates a perspective view of the removable filter housing of the embodiment of FIG. 1A with the filter member removed.

FIG. 2B illustrates a partial cross-sectional view of the removable filter housing of the embodiment of FIG. 1A, as taken along line 2B-2B of FIG. 1A.

FIG. 2C illustrates a bottom view of the removable filter housing of the embodiment of FIG. 1A.

FIG. 2D illustrates a top view of the removable filter housing of the embodiment of FIG. 1A.

FIG. 3 is a perspective view of a second embodiment of a covered animal litter box employing a removable filter housing.

FIG. 4 is a perspective view of a third embodiment of a covered animal litter box including an automatic filter connected to the litter box.

FIG. 5 is a front elevation view of the covered animal litter box illustrated in FIG. 4.

FIG. 6 is a bottom perspective view of one embodiment of the automatic filter removed from the covered animal litter box.

FIG. 7 is a perspective view of the covered animal litter box including a second embodiment of the automatic filter connected thereto.

FIG. 8 is a perspective view of the embodiment of the automatic filter illustrated in FIG. 7.

FIG. 9 is a rear elevation view of the automatic filter illustrated in FIG. 7.

FIG. 10 is a side elevation view of the automatic filter illustrated in FIG. 7.

FIG. 11 is a perspective view of the automatic filter illustrated in FIG. 7 with the battery door and the storage door removed.

FIG. 12 is an exploded view of the automatic filter illustrated in FIG. 7.

FIG. 13 is a perspective view of the filter base with the filter casing removed.

FIG. 14 is a bottom plan view of the automatic filter.

FIG. 15 is a top plan view of the automatic filter with the filter casing removed.

FIG. 16 is a top perspective view of the dispensing plate of the filter removed from the automatic filter.

FIG. 17 is a cross-section view of the automatic filter viewed in FIG. 8, taken along line 17-17 in FIG. 8.

FIG. 18 is an enlarged view of the connection between the covered litter box, the filter base and the dispensing plate.

FIG. 19A is a perspective view of a third embodiment of the automatic filter.

FIG. 19B is a side elevation view of the embodiment of the automatic filter illustrated in FIG. 19A.

FIG. 20 is a cross-section view of the automatic filter illustrated in FIG. 19A viewed along line 20-20 in FIG. 19A.

FIG. 21 is a top perspective view of the filter base of the automatic filter illustrated in FIG. 19A with the filter casing removed.

FIG. 22 is a top perspective view of the filter base with the filter casing and the control button removed.

FIG. 23 is a top plan view of the filter base.

FIG. 24 is a flow chart illustrating one embodiment of an activation process for the automatic filter.

### DETAILED DESCRIPTION

Embodiments disclosed herein may take the form of a litter box having a base portion and a cover portion. The base portion may include a floor and a plurality of walls extending in an upward direction from the floor. The cover portion may have a ceiling and a plurality of walls extending in a downward direction from the ceiling. The litter box may further have a removable filter member configured to receive a filter member. The removable filter member may be configured to hold a filter member, and may define one or more vents. One of the cover portion and the base portion may be configured to receive the removable filter member.

Other embodiments may include an automatic filter. The automatic filter may attach to, or be inserted (partially or fully), in the cover portion of the litter box. The automatic filter may sense when an animal has entered and exited the litter box. After the animal exits the automatic filter may deposit a layer of deodorizer onto the bottom surface of the litter box, helping to eliminate and/or disguise odors from the animal's waste in. In addition to a sensor, the automatic filter may include a motor and a dispensing plate. The dispensing plate dispenses the deodorizer in response from a signal from the sensor, and is operated by the motor. In some embodiments, the automatic filter may be additionally controlled by user control buttons, allowing a user to dispense a layer of deodorizer whenever he or she may desire.

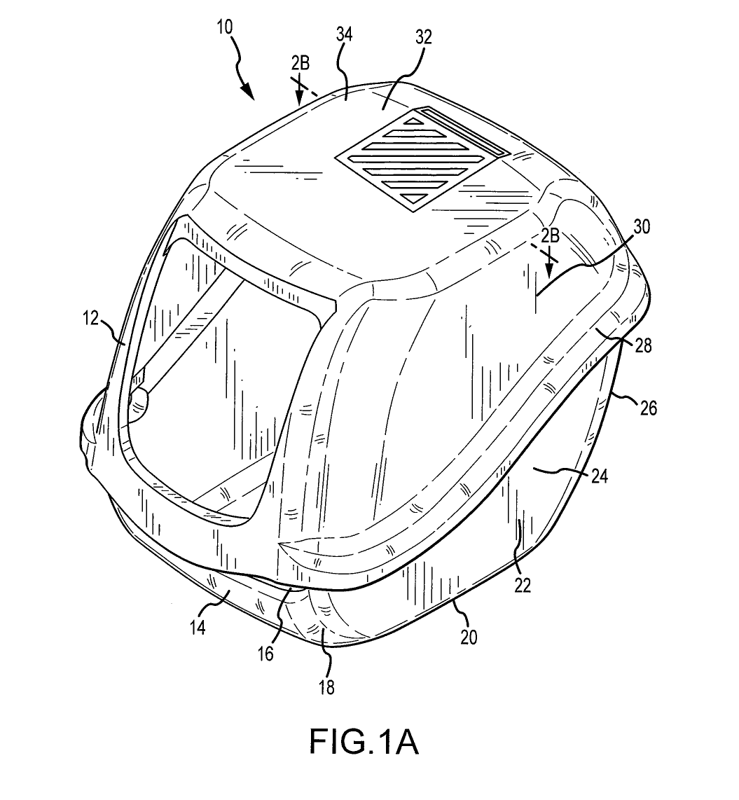

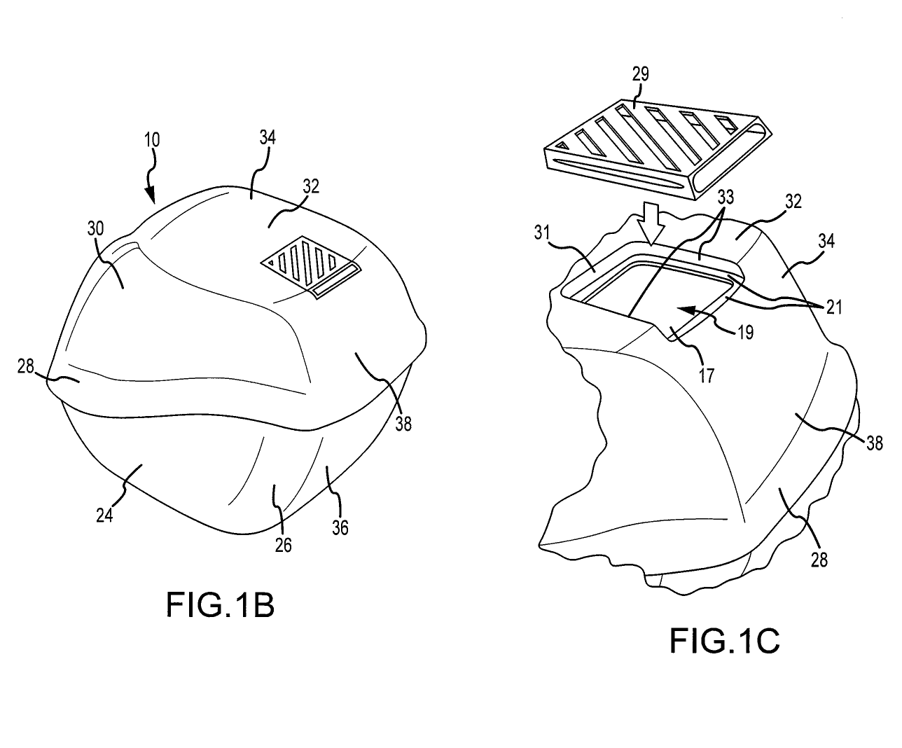

Referring now to FIGS. 1A-1C, the animal litter box housing 10 may include a litter box base 22 and a litter box cover 34. In one embodiment, the litter box base 22 may be provided with side walls 24 that extend upwardly from the litter box base 22, a forwardly inclined front wall 14 with respect to the litter box base 22, a pair of upwardly extending forward wall portions 18 joining the side walls 24 with the front wall 14, and a pair of inclined angularly disposed rear wall portions 26 joining the side walls 24 with the inclined rear wall. An inverted upper perimeter edge portion 16 is defined by the upper ends of the forward wall portions 18, side walls 24, rear wall portions 26 and the rear wall 36. Additionally, the bottom surface 20 of the housing may include a plurality of pegs, legs, a high-friction coating covering a portion or all of the bottom surface 20, and/or other supports to support and stabilize the litter box base 22 when it rests on a generally flat surface. Some examples of frictional surfaces include rubber feet, roughened feet, and feet formed from a soft plastic, thermoplastic or suitable resin.

The mating litter box cover 34 generally corresponds in configuration to the litter box base 22, such that the lower surface of the cover 34 and the upper surface of the base 22 may abut when the two are placed together. The cover 34 may include a top surface 32, sidewalls 30, a front wall 12, and a rear wall 38. The cover 34 may also define a lower perimeter lip portion 28 joined to the top surface 32, sidewalls 30, front wall 12 and/or rear wall 38. The lip portion 28 may be adapted to extend over and engage the upper perimeter edge portion of the litter box base 22 when the cover 34 is disposed on the litter box base 22. In the embodiment illustrated in FIGS. 1A-1C, an opening may be defined at least partially by the front wall 12 of the litter box cover 34 to provide an entrance for an animal into the litter box when the cover 34 is disposed atop the litter box base 22. Alternatively, the animal entrance could be provided in the front wall 14 of the litter box base 22, or partially in the litter box base 22 and partially in the cover 34 so that the opening is defined by both the cover 34 and the base 22.

The cover 34 and/or the litter box base 22 may include a locking mechanism configured to removably secure the cover 34 to the litter box base 22 so as to prevent the cover 34 from becoming disengaged from the base 22 when the litter box housing 10 is moved or picked up, for example. In some embodiments, the perimeter lip portion 28 of the cover 34 may define alignment features that are received by slots defined in the perimeter edge portion of the litter box base 22. Other embodiments may include locking tabs and/or snaps positioned around the perimeter of the litter box base 22 and/or the cover 34. Additionally, in some embodiments, the litter box cover 34 may be hingedly connected to the litter box base 22.

The litter box housing 10 may be made of a polymer or other suitable material. For example, the housing 10 may be formed of a styrene, a polypropylene, a polyvinyl chloride (“PVC”), or a polyethylene terephthalate (“PET”), among other materials.

The top surface 32 of the cover 34 may define an opening therein adapted to receive a filter housing 29 supporting a filter member 39. As shown in FIG. 1C, for example, the opening 19 may be positioned toward the rear end of the top surface 32 of the cover 34. In other embodiments, the opening 19 may be positioned anywhere along the top surface 32 of the cover 34, including toward the front end of the cover 34, the sidewalls 30 of the cover 34, and/or the middle of the cover 34. In further embodiments, the opening 19 may be positioned anywhere along the litter box base 22.

One or more sidewalls 33, generally defined in the top surface 32 of the cover 34, may be adjacent to the opening 19. For example, the opening 19 may be lined by a front wall 31, as well as right and left sidewalls 33, while the rear end of the opening 19 may be left open to facilitate insertion of the filter housing 29 into the cover 34. Still referring to FIG. 1 C, the cover 34 may further define one or more bottom ledges 21 extending perpendicularly from the bottom edge of the sidewalls 33 defining the opening 19 and toward the center of the opening 19. The bottom ledges 21 may be configured to support the filter housing 29 and prevent the housing 29 from falling through the opening 19 into the litter box 10 interior.

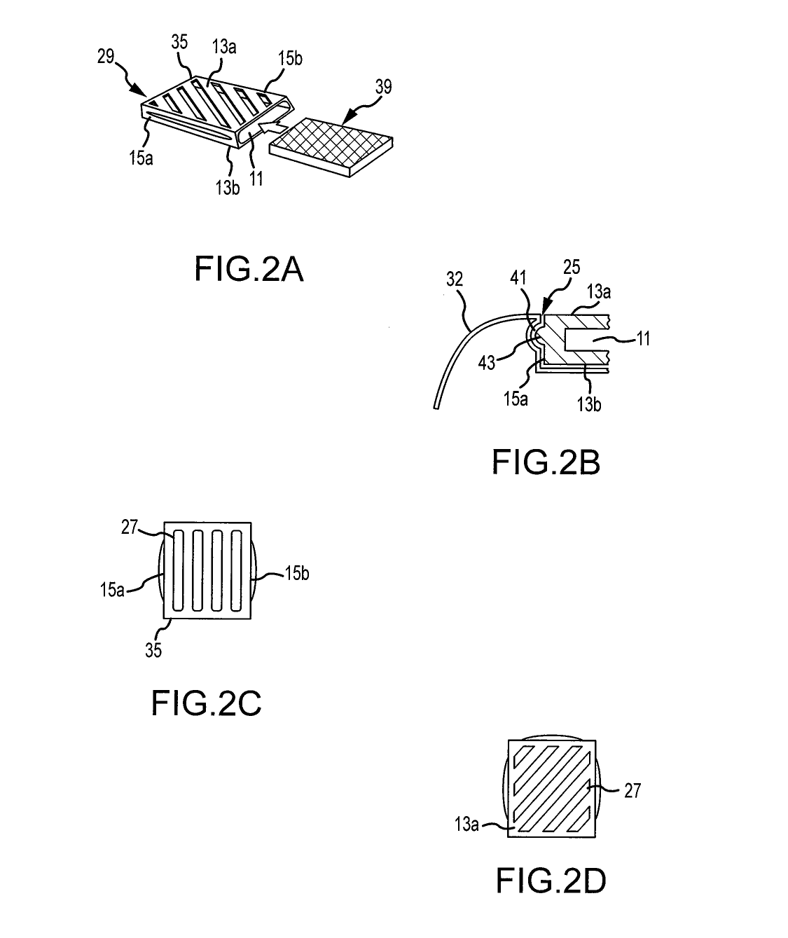

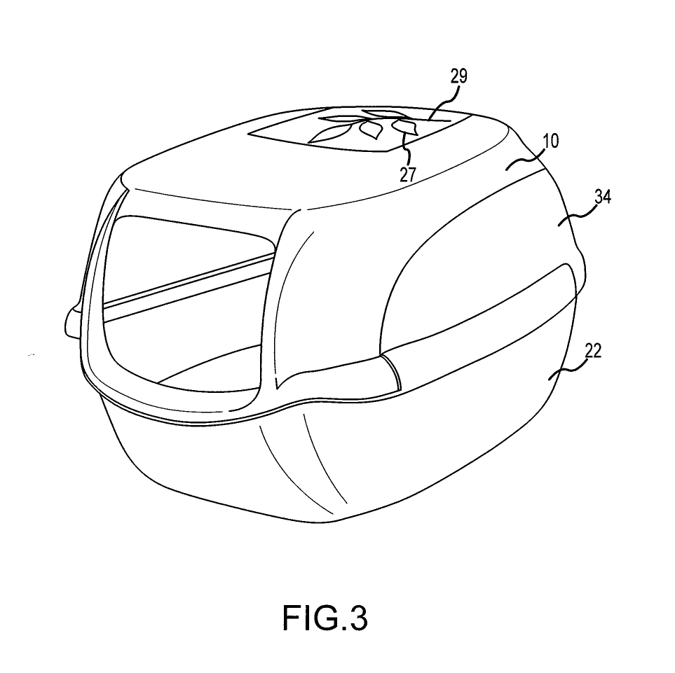

As best shown in FIG. 2A, the filter housing 29 may have a generally rectangular configuration, and may include top wall 13a, a bottom wall 13b, a rear wall 35, and right and left sidewalls 15a, 15b. One end of the filter housing 29 may further define a slot 11 configured to receive a filter member 39 therein. This filter member 39 may act to reduce odors emanating from the litter box 10. The filter member 39 may be of single piece construction and may be configured to be received within the filter housing 29. In other embodiments, the filter member 39 may be made in any shape and/or as multiple pieces. The filter 39 may be a diffuser, potpourri, gel, and/or a mechanical or heat release product, and so on and so forth.

In one embodiment, the outer surfaces of the rear 35, right 15a, and left sidewalls 15b of the filter housing 29 may include guide rails 43 configured to engage corresponding guide slots 41 provided along the exterior of one or more of the opening's 19 cover walls. The guide slots 41 may receive the guide rails 43 of the filter housing 29, thereby facilitating inserting the filter housing 29 into the litter box cover 34 by sliding the guide rails 43 onto the guide slots 41. The thickness and/or length of the recessed portions may further be configured so as to prevent or reduce vertical and/or movement of the filter housing 29 with respect to the litter box cover 34 once the housing 29 is inserted therein. In other embodiments, the filter housing 29 may be inserted into the litter box cover 34 in other ways, including by aligning the filter housing 29 with the sidewalls 33 defined by the cover 34 and dropping the filter housing 29 over the opening 19, and so on.

As shown in FIG. 2D, the top and bottom walls 13a, 13b of the filter housing 29 may include one or more vents or slots 27. The vents 27 may be formed in any configuration including, but not limited to vertical, diagonal slots, horizontal slots, circular apertures and so on. The vents 27 along the bottom walls 13b of the filter housing 29 may allow for dissemination of a substance and/or a scent from the filter member 39 to the interior of the litter box 10, as well as facilitate the absorption of litter box odors by the filter member 39. Additionally, the vents 27 along the top walls 13a of the filter housing 29 may allow for passage of air from litter box 10 interior, through the filter member 29 to the exterior of the litter box 10.

FIG. 3 illustrates a further embodiment of the animal litter box 10 with a removable filter housing 29. As shown in FIG. 3, the vents 27 or defined by the top and bottom walls 13a, 13b of the filter housing 29 may be any configuration, and may be arranged to form a decorative design. Additionally, the vents 27 along the top and bottom walls 13b of the filter housing may or may not match.

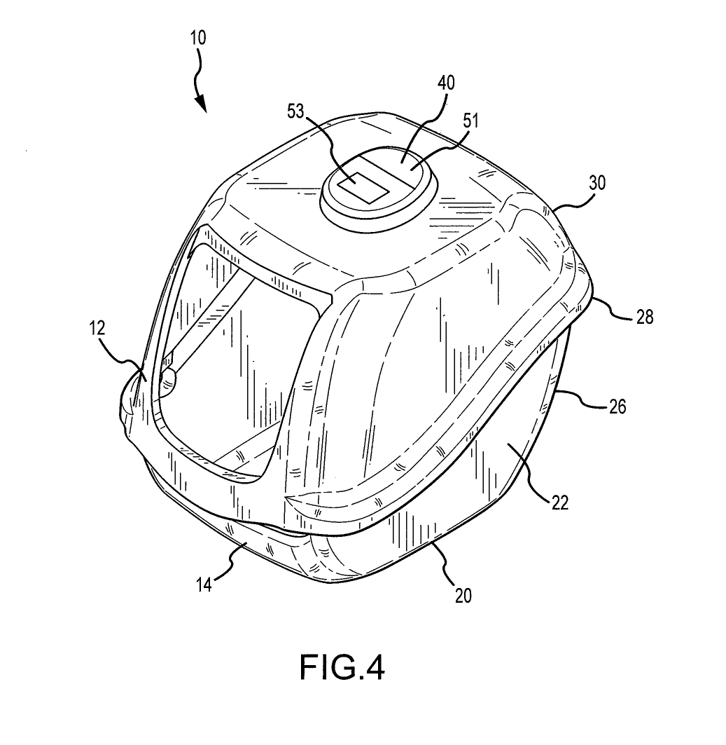

In other embodiments, the filter housing 29 may further be configured to activate an electrical device and/or the filter housing 29 may include an automatic filter 40 coupled to the litter box 10, as, for example, in the embodiments shown in FIGS. 4, 7, and 19A. Additionally, in some embodiments, the filter housing 29 and filter member 39 may be operably connected to the automatic filter, such that there may be two separate filtering mechanisms for the litter box 10. In other embodiments, the opening 19 may be configured to receive the automatic filter. In these embodiments, the opening 19 may be located near or at the middle of the top surface 32 of the cover 34.

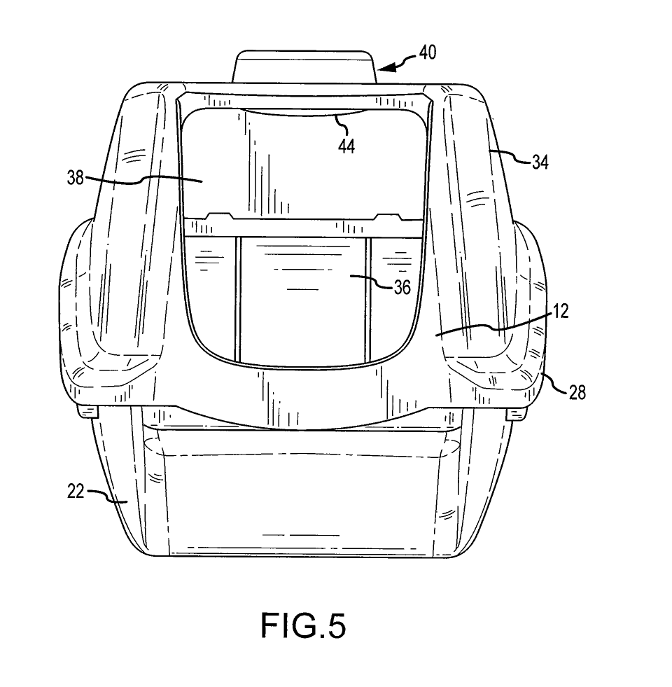

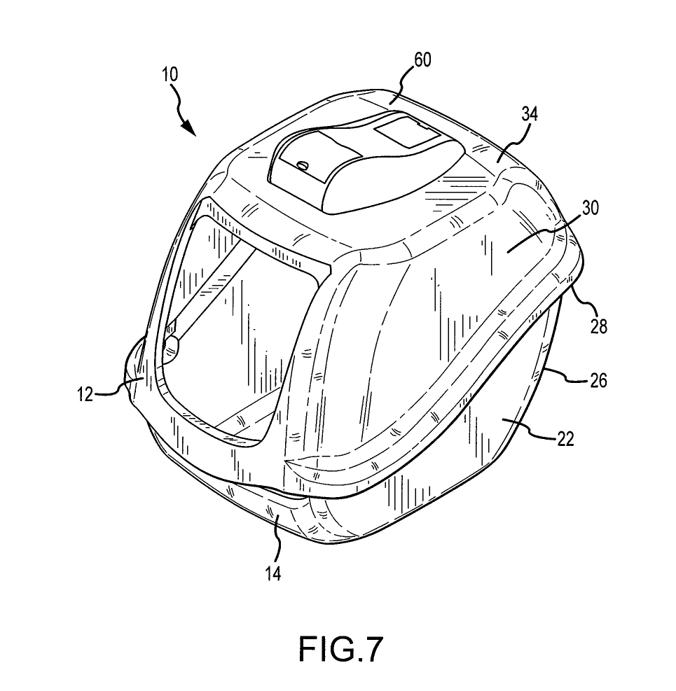

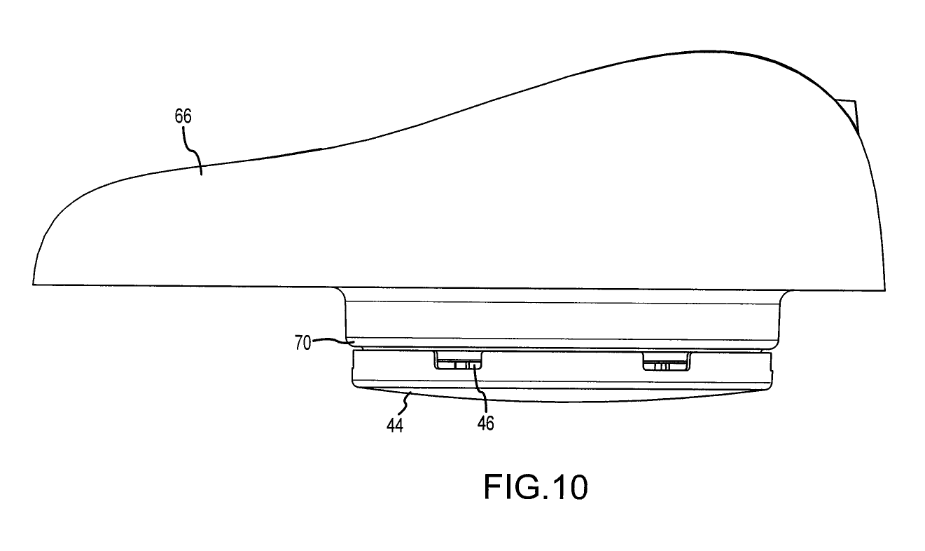

FIG. 4 illustrates a perspective view of the litter box 10 coupled to an automatic filter 40, while FIG. 7 illustrates a perspective view of a second embodiment of the automatic filter 60 installed on the litter box 10, and FIG. 10A illustrates a perspective view of a third embodiment of the automatic filter 140. The automatic filters 40, 60, 140 may function in essentially the same fashion, but may include differently shaped filter covers and/or casings. For example, referring to FIGS. 4 and 5, the first embodiment of the automatic filter 40 may have a substantially oval-shaped filter housing 52, whereas the filter case 61 for the second embodiment of the automatic filter 60 may have a wave-like upper surface, as shown in FIG. 7. The third embodiment of the automatic filter 140 may have substantially the same shape as the second embodiment of the automatic filter 60. Accordingly, it should be appreciated that the filter may take a variety of shapes, only some of which are illustrated herein. Additionally, each filter 40, 60, 140 may be configured to be activated either via a sensor, timer, and/or mechanical element (e.g., an activation button), and the like. For example, the first and second filter embodiments 40, 60 may be activated automatically, and the third filter 140 embodiment may be activated via an activation or control button or switch. Furthermore, as the filter housing 29 may be operably connected to the automatic filters 40, 60, 140, each embodiment may include a passive filter component (e.g., filter member 39), in addition to the deodorizer to be dispensed within the litter box 10.

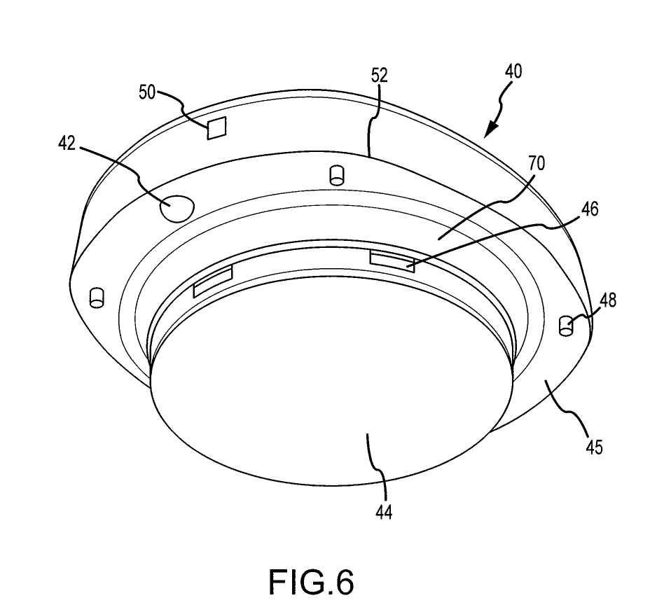

Referring now to FIGS. 4-6, the first embodiment of the automatic filter 40 may be inserted at least partially into an aperture (similar to the opening 19 illustrated in FIG. 1C) defined on the top surface 32 of the litter box 10. A dispensing plate 44 of the automatic filter 40 may extend through the aperture and into the internal cavity formed by the cover 34 and the base 22. When operating, the automatic filter 40 may emit a deodorizer (e.g., sodium bicarbonate), or any other suitable freshener, filtering material, or the like into the inner surface of the litter box 10. The automatic filter 40 generally includes the dispensing plate 44, plate apertures 46, a filter casing 52, control buttons 50, a sensor 42 and a supporting surface 45. The automatic filter 40 may be removed from and refitted to the litter box 10 as desired, thereby allowing a user to remove the automatic filter 40 in order to clean the litter box 10, clean the automatic filter 40, refill the automatic filter 40 with deodorizer, and/or replace the batteries/power source.

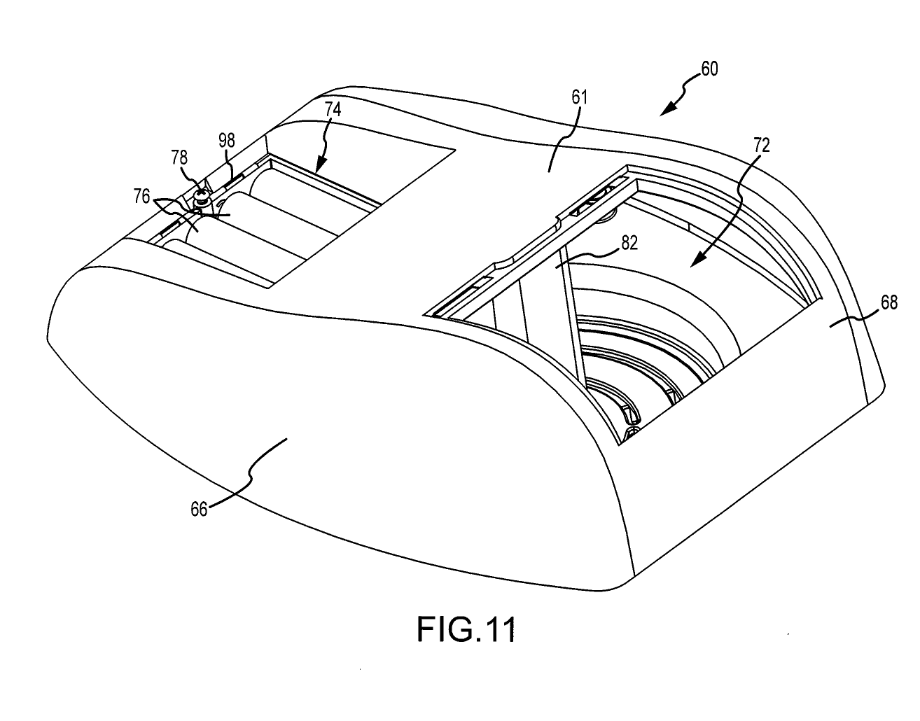

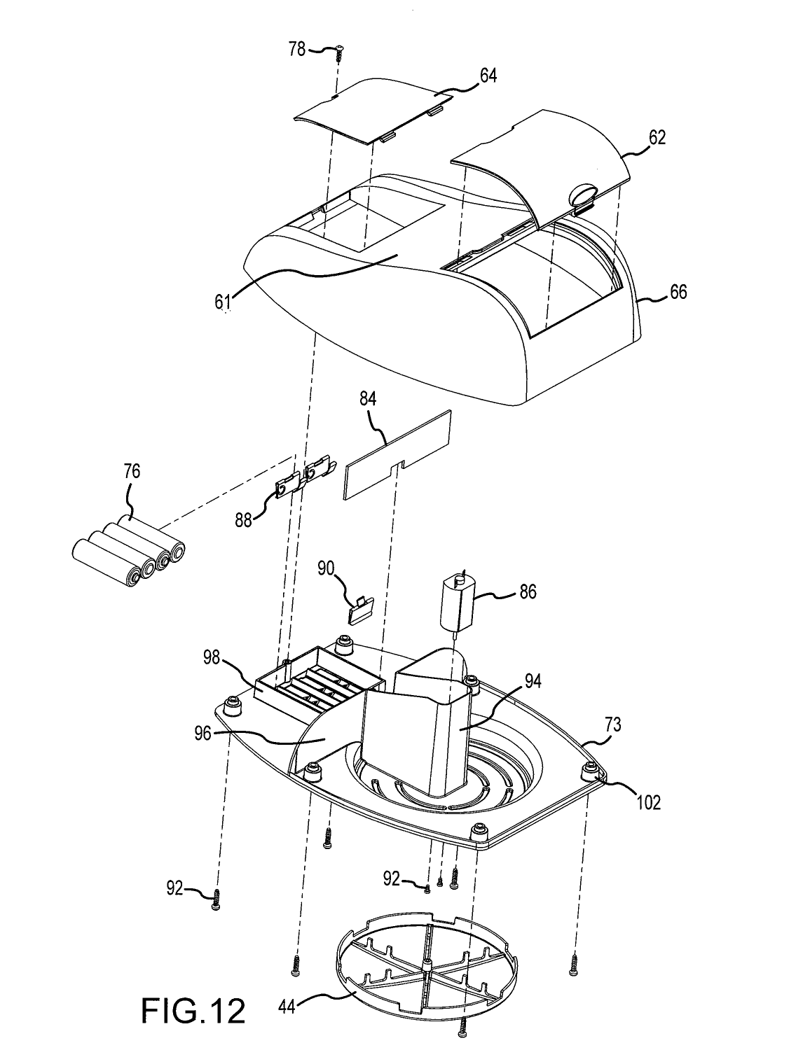

A storage cavity is defined within the filter casing 52; the filter casing 52 likewise surrounds electrical components of the filter 40 and a power source (discussed in more detail below with regard to FIGS. 11-12). The filter casing 52 also includes a storage door 51 and power source door 53. The filter casing 52 sits on the top surface 32 of the litter box 10 and the two doors 51, 53 open to allow a user to access the storage cavity and the power source. For example, the storage door 51 may open to allow a user to refill the storage cavity with the deodorizer and/or air freshening materials. Similarly, the power source door 53 may be removed/opened to access batteries or other electrical power sources.

In the present embodiment, the bottom surface 45 of the filter casing 52 supports the automatic filter 40 on the litter box. For example, in some embodiments the bottom surface 45 includes pegs 48 or other securing structures that may be inserted into corresponding peg apertures (not shown) along the top surface of the litter box to support the filter 40 to prevent accidental decoupling of the filter 40 from the litter box 10. Additionally, either the dispensing plate 44 or the bottom surface 45 also may include a sensor 42. In embodiments employing the sensor 42, the sensor 42 may typically be located on a portion of the filter casing 52 that extends into the internal cavity of the litter box 10, such that the sensor 42 may sense movement, heat, light or the like or other changes in the litter box 10 in order to detect whether an animal has entered/exited the litter box. The sensor 42 may be, for example, an infrared sensor, radio frequency sensor, movement sensor, or the like.

The dispensing plate 44 is operably connected to the filter casing 52 by a neck 70. The neck 70 extends below the supporting surface 44 and secures the dispensing plate 44 to the automatic filter 40. Plate apertures 46 may be spaced along the top perimeter of the dispensing plate 44; deodorizer is stored in a number of chambers within the dispensing plate 44. When the automatic filter 40 is activated, the dispensing plate 44 may rotate and dispense the deodorizer out of the filter 40 via the plate apertures 46. These features are discussed in more detail below with regard to the second and third embodiments of the automatic filter.

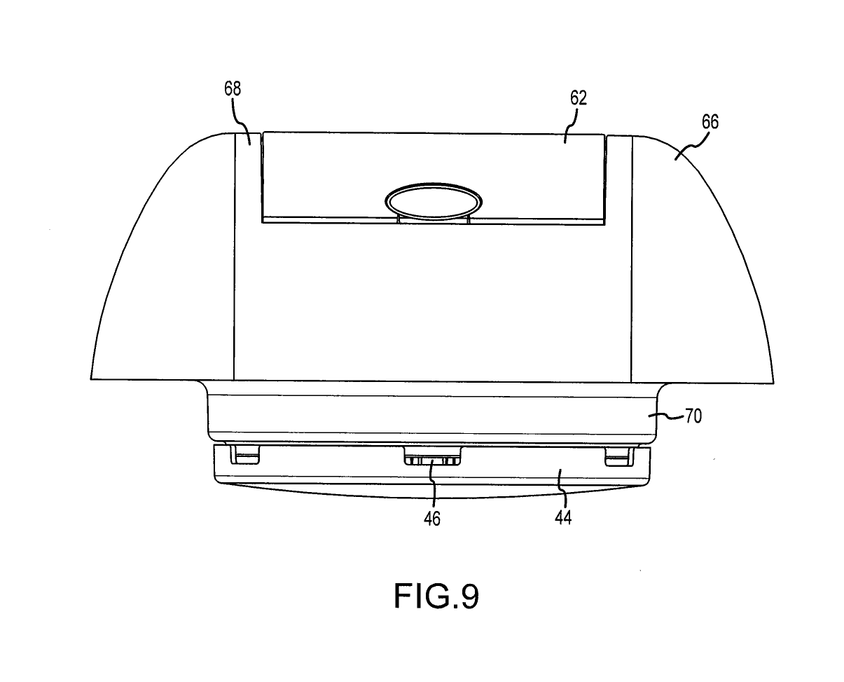

Referring now to FIGS. 7-10, in a second embodiment of the automatic filter 60, the upper surface filter casing 61 may be curved or formed from compound curves. The automatic filter 60 may take a variety of forms and so the illustrated configuration is meant as an example only. Similar to the first embodiment of the automatic filter 40, in this embodiment the automatic filter 60 includes a storage cavity door 62 and a power source door 64. These doors are substantially similar to the doors 51, 53 illustrated in FIG. 4, and provide access to the storage cavity 72 and power source cavity 74 (illustrated in FIG. 11), respectively. In some embodiments, the doors 62, 64 may swing open and be operated by a push button, tab, latch or the like.

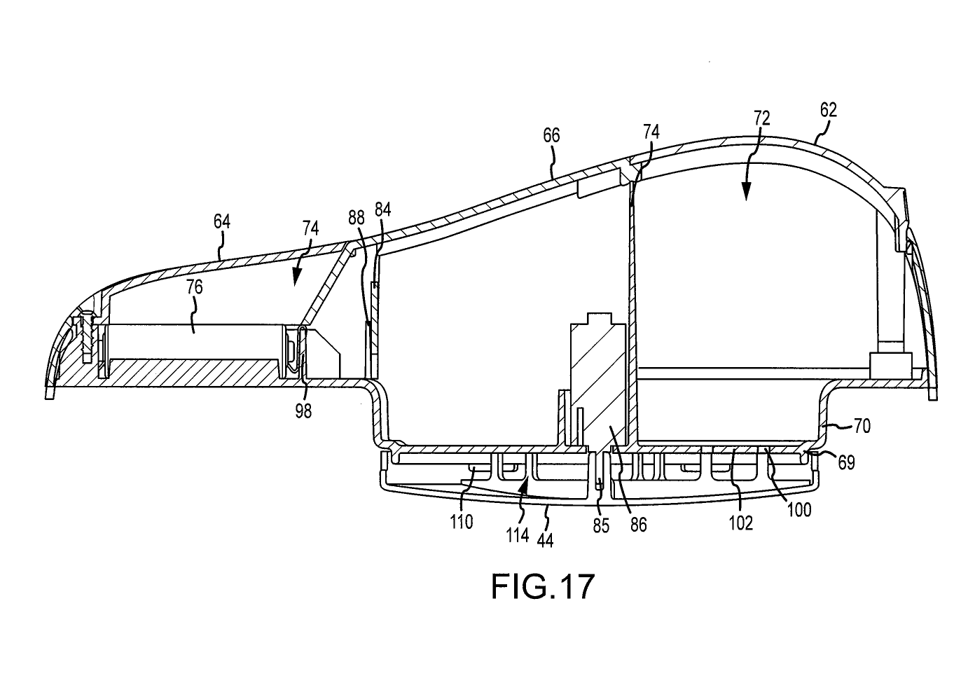

The casing 61 sits atop the litter box 10 and forms the main body of the automatic filter 60. The casing 61 is operably attached to the base 73, for example, via a snap-fit connection, fasteners, or pegs. A neck 70 of the base 73 extends below the top surface of the litter box and into the interior cavity of the litter box. The neck 70 attaches to the dispensing plate 44. Referring briefly to FIG. 17, the inner portion of the neck 70 may include a curved portion 69 and the top perimeter of the dispensing plate 44 may be inserted into the space created by the curvature of the curved portion 69, thereby operably connecting the neck 70 and the dispensing plate 44.

FIG. 11 illustrates the automatic filter 60 with the doors 62, 64 removed. In the present embodiment, a storage cavity 72 holds the deodorizer to be dispensed via the automatic filter 60. For example, in certain embodiments the automatic filter 72 (or other filter/dispenser discussed herein) may dispense a deodorizer such as charcoal, compressed newspaper or other paper material, minerals such as zeloite, sodium bicarbonate or other similar materials. Additionally, the deodorizer may be odorless, although in other embodiments the deodorizer may be scented in order to help disguise odors that may be present in the litter box. In some embodiments, the deodorizer may be added into the storage cavity 72 and then dispensed via the dispensing plate 44 into the litter box. In these embodiments the storage cavity 72 may be connected to the dispensing plate 44 via the neck 70, allowing the deodorizer to be transported between the storage cavity 72 and the dispensing plate 44. It should be noted that the size and the capacity of the storage cavity 72 may be altered to accommodate larger/smaller amounts of deodorizer.

In other embodiments, the storage cavity 72 may be designed to receive a cartridge or other packaging including the deodorizer. In such embodiments, the deodorizer may be preloaded in the packaging, which is inserted into the storage cavity 72. This may be simpler for a user than filling the storage cavity 72 with loose filter material. For example, while a user is attempting to fill the storage cavity 72 some material may spill onto the sides of the litter box or even onto the user's floor and the like. With a prepackaged cartridge or the like, such spillage may be substantially eliminated.

The power storage cavity 74 may be used to store batteries 76 or, in other embodiments, certain electrical connections. For example, if the automatic filter 60 includes a wired power source, the storage cavity 74 may provide an area for a direct current/alternating current adapter, power cord or the like. In other embodiments, the power storage cavity 74 may be omitted, for example, if the automatic filter 60 is powered by a power cord or the like. In some embodiments, the power storage cavity 74 may include a battery cradle 98 to support the batteries 76. The cradle 98 may include separating walls, grooves, indentations, or the like to retain the batteries 76 in place. The cradle 98 may be designed to accommodate a variety of batteries types and/or sizes. For example, in some embodiments the batteries 76 may be AAA, AA, A, 9-Volt, or the like; and the design, shape and size of the cradle 98 may be altered to accommodate the different orientations and sizes of the various batteries 76. Similarly, although four batteries 76 have been illustrated, the automatic filter 60 may employ any other number of batteries 76 depending on the power output required.

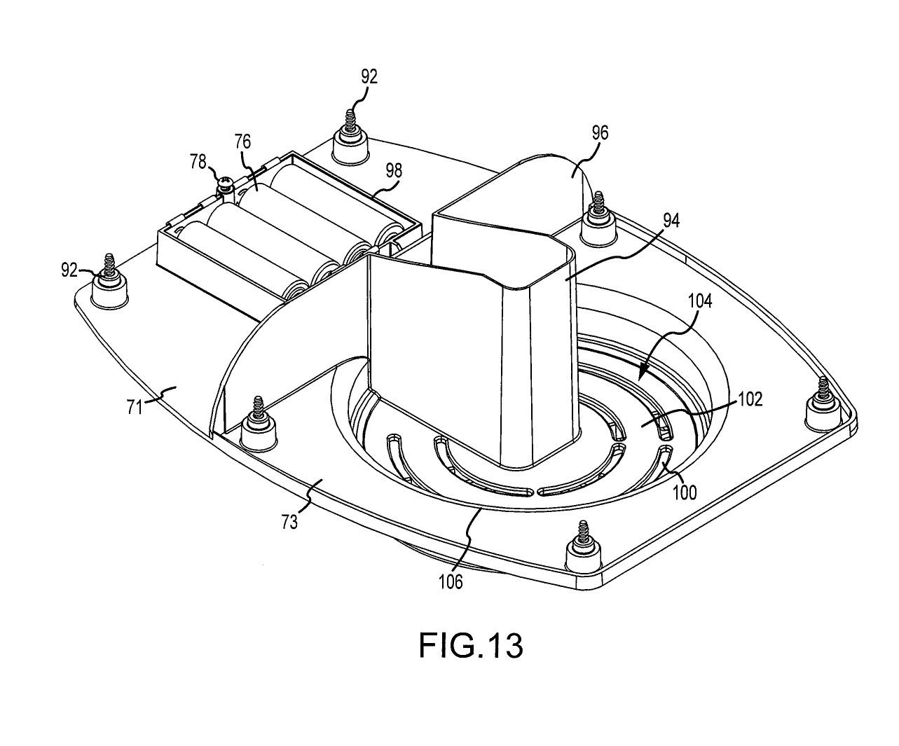

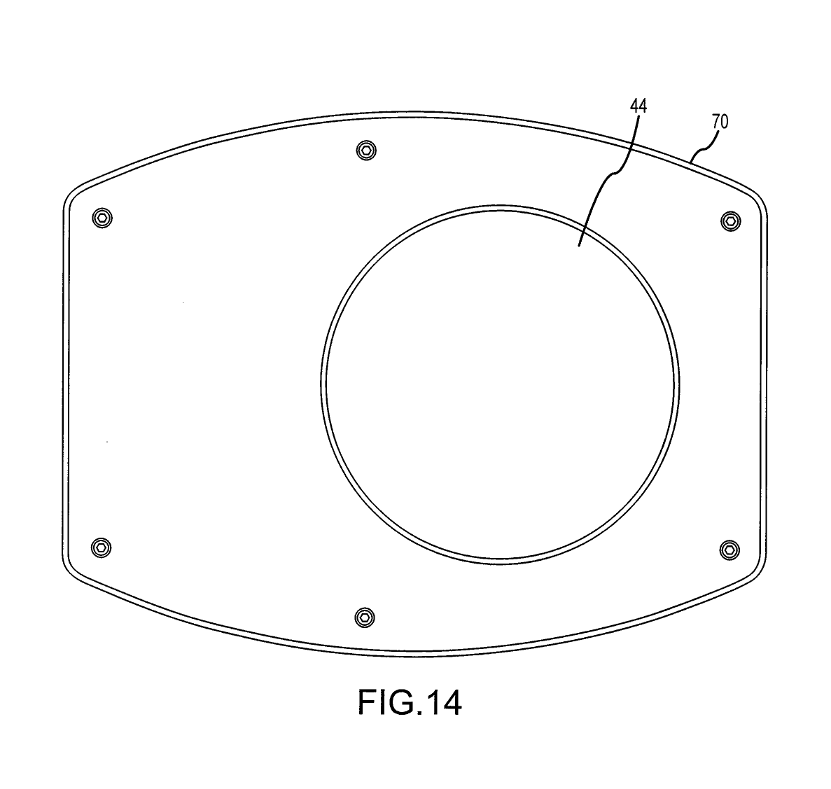

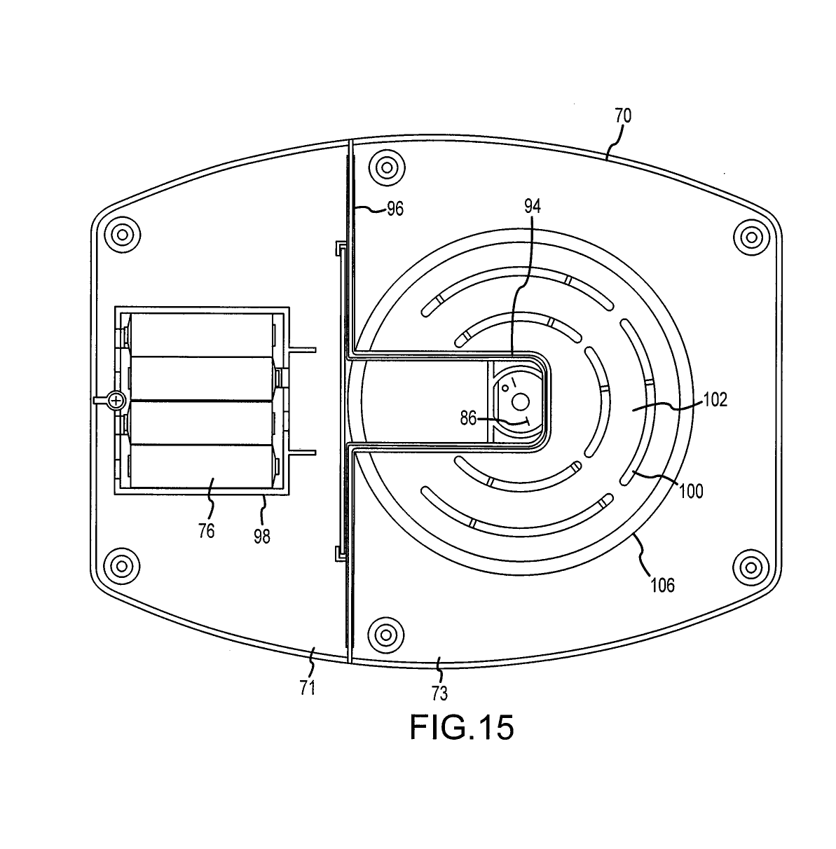

FIGS. 12-15 will now be discussed. FIG. 12 illustrates an exploded view of the second embodiment of the automatic filter 60. FIG. 13 illustrates a top perspective view of the base 73 of the filter 60 with the top casing 61 removed. FIG. 14 illustrates a bottom plan view of the automatic filter 60. FIG. 15 illustrates a top plan view of the automatic filter 60 with the top casing 61 removed. Referring now to FIGS. 12, 13 and 15, the casing 61 fits substantially over the base 73. The base 73 extends into the neck 70 and operably connects to the dispensing plate 44. The storage cavity 72 (see, e.g., FIG. 11) is created in the space between the casing 61, the base 73 and the dividing wall 94, as well as the dividing wall's 94 wings 96. As the storage cavity 72 holds deodorizer, the deodorizer may sit on the top surface of the base 73 and/or the dispensing floor 102. The dividing wall 94 and the wings 96 may substantially prevent the deodorizer from entering the back area 71 of the base 73. The wings 96 and the dividing wall 94 may help prevent the deodorizer from substantially interfering with the electrical communications between the batteries 76 and/or the motor 86. This may be beneficial, as the deodorizer may include loose particles that could damage moving parts, electrical components and/or electrical connections.

The case 61 may snap-fit or otherwise attach to the base 73, and the base 73 may be secured to the litter box 10 by fasteners 92. The fasteners 92, similar to the pegs 48 in the first embodiment of the automatic filter 40, may be inserted into corresponding apertures on the litter box 10 top surface 32 (not shown). In some embodiments, the base 73 may be secured to the litter box 10. For example, the base 76 may include pegs 48 or other fasteners, or may be connected in a snap-fit fashion.

The dividing wall 94 extends upwardly from the base 73 and separates the back portion 71 of the base 73 from the storage cavity 72. The dividing wall 94 also partially surrounds a motor 86 and substantially prevents the deodorizer from reaching the motor 86. The dividing wall 94 may be shaped as an open-ended rectangle with the open end facing the back portion 71 of the base 73. In these embodiments, a top end of the dividing wall 94 may be located substantially at the center of the dispensing plate 44. This implementation allows the dispensing plate 44 to be coupled to the motor 86, thereby allowing the motor to rotate the dispensing plate 44. Wings 96 extend from the back portion of the dividing wall 94 and help to push the deodorizer onto a dispensing floor 102. In other implementations the wings 96 may extend from other areas of the dividing wall 96 or may be omitted. For example, in some embodiments the dividing wall 94 may completely enclose the motor 86, while the back portion 71 may be a portion of the storage cavity 72.

The dispensing floor 102 forms the bottom surface of the storage cavity 72. Deodorizer stored in the storage cavity 72 sits atop the dispensing floor 102 and is transmitted to the dispensing plate 44 via the floor apertures 100. Depending on the deodorizer, the floor apertures 100 may vary in size. For example, if sodium bicarbonate is used, the floor apertures 100 may be smaller than if compressed paper material is used. Additionally, the floor apertures 100 may be shaped in a variety of different manners. Although the floor apertures 100 are illustrated as concentric rings, they may be a series of regular or irregular, circular, triangular, and the like openings dispersed along the dispensing floor 102.

The dispensing floor 102 may be recessed below an upper surface of the base 73. In these embodiments, the dispensing floor 102 may form a cup or bowl shape underneath the storage cavity 72. However, in other embodiments the dispensing floor 102 may be substantially flush with the top surface of the base 73. Additionally, in some embodiments, the dispensing floor 102 may be shaped approximately the same as the dispensing plate 44. For example, in the embodiment illustrated in FIG. 12, the dispensing plate 44 and the dispensing floor 102 may be substantially circular. However, in other embodiments, the dispensing floor 102 may be shaped differently from the dispensing plate 44. Furthermore, in some embodiments the dispensing floor 102 may be omitted. For example, the base 73 may include an aperture, a series of apertures or the like, and the dispensing plate 44 may act as the dispensing floor 102 as well as the dispensing plate 44.

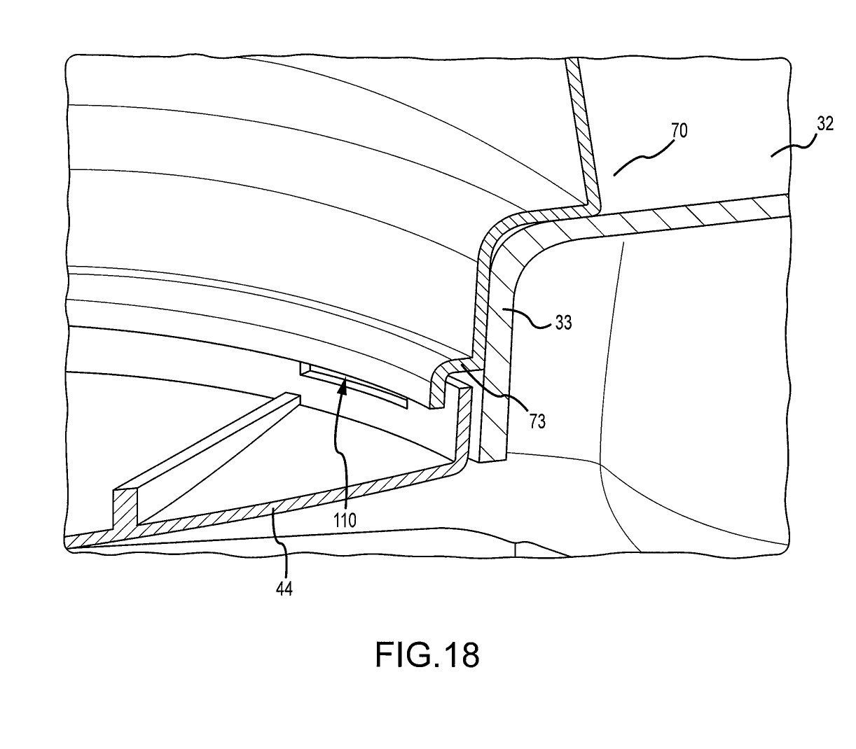

The base 73 may also support a processor on board 84. The circuit board 84 may be electrically connected to the sensor 42 (if present) and the motor 86. The circuit board 84 may be supported against the dividing wall 94 via a support 84. The circuit board 84 operates the motor 86; such operation may be in response to signals generated by the sensor 42. Additionally, in some embodiments, the circuit board 84 may be programmed with particular wait times, scan times and the like to determine when the deodorizer may be dispensed into the litter box (see e.g., FIG. 18). It should be noted that although the circuit board 84 is illustrated, the motor 86 itself or the sensor 42 may include other control electronics or the like and the circuit board 84 may be omitted.

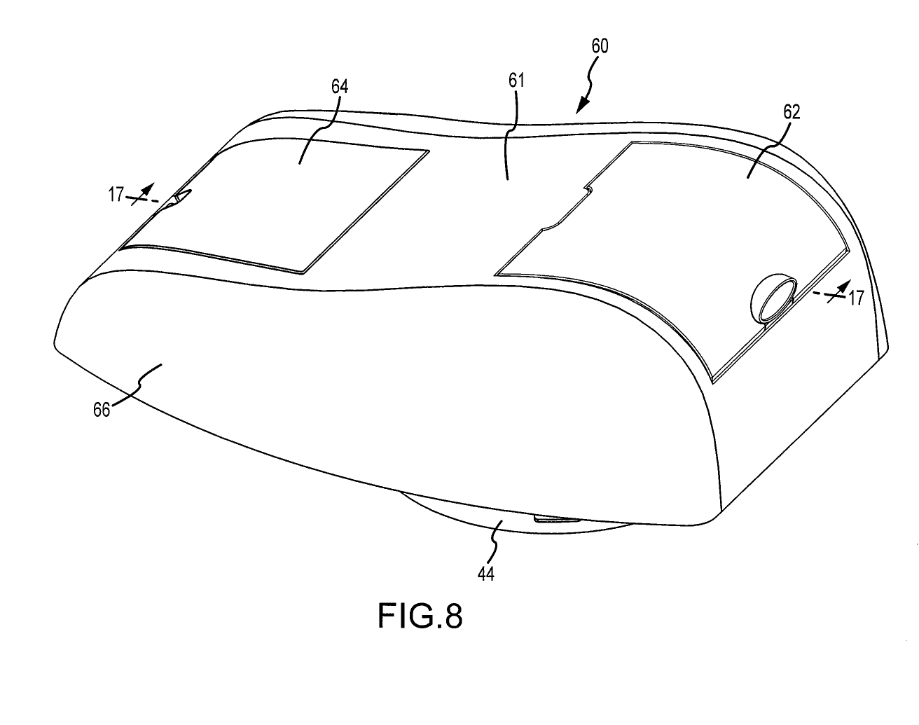

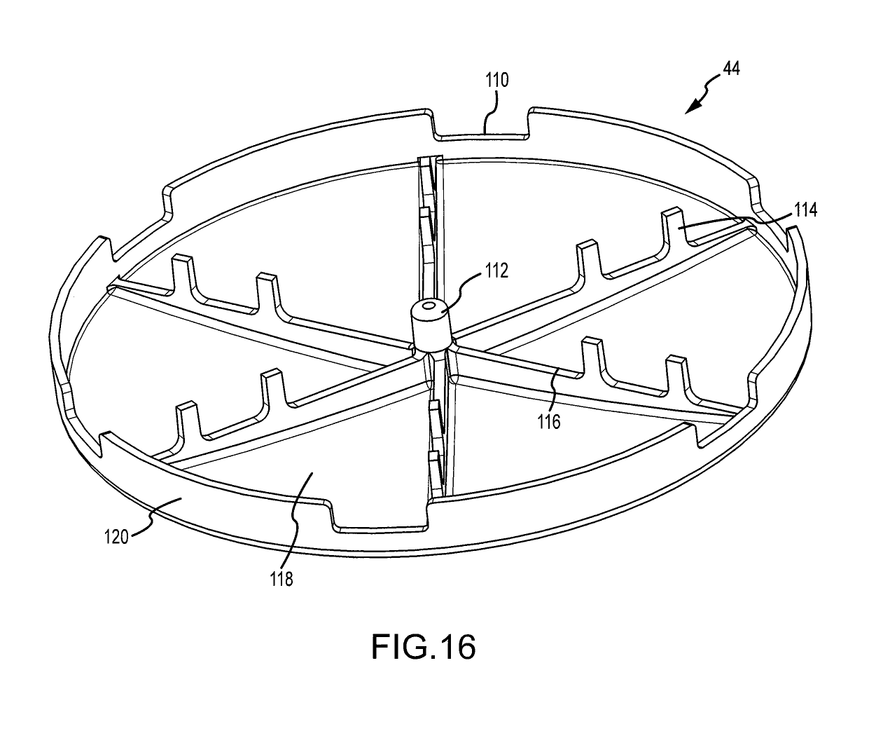

FIG. 16 illustrates one embodiment of the dispensing plate 44 removed from the automatic filter 60. FIG. 17 illustrates a cross-section view of the automatic filter 60, viewed along line 17-17 in FIG. 8. FIG. 18 illustrates an enlarged, partial inner view of the dispensing plate 44 connected to the neck 70 and the dispensing floor 100. Referring now to FIGS. 16-18, in the present embodiment the dispensing plate 44 connects to the motor 86 via a connecting neck 112. The connecting neck 112 extends from the center of the dispensing plate 44 and is operably attached to a drive shaft 85 extending from the motor 86. In some embodiments, the drive shaft 85 may be received within a receiving aperture 115 in the connecting neck 112. In these embodiments, the motor 86 is rotates the dispensing plate 44 by rotating the drive shaft 85, which in turn rotates the connecting neck 112. Expanding outwards from the connecting neck 112 are raking walls 116. The raking walls 116 are spaced intermittently around the top surface of the dispensing plate 44 and include raking prongs 114. In these embodiments, the raking prongs 114 extend partially into the floor apertures 100. When the dispensing plate 44 rotates the raking prongs 114 disturb the deodorizer in the storage cavity 72 causing the material to fall through the floor apertures 100, as explained in more detail below. Additionally, the raking walls 114 and raking prongs 116 help prevent the deodorizer from clogging or blocking the floor apertures 100, as the raking prongs 116 scrape the deodorizer from the floor apertures 100.

The raking walls 116 may include any number of raking prongs 114. In some embodiments, there may be at least one raking prong 114 for each floor aperture 100. Additionally, depending on the implementation of the floor apertures 100, the raking walls 116 may vary in size, shape, configuration, number and the like. Furthermore, in some embodiments the raking walls 116 and corresponding raking prongs 114 may be omitted. In these embodiments, the dispensing plate 44 may be substantially planar.

The perimeter of the dispensing plate 44 may be surrounded by a dispensing wall 120. The dispensing wall 120 includes cutouts 110 that form plate apertures 46 when connected to the base 73 and/or the neck 70. The cutouts 110 may be any shape and/or size depending on the amount of deodorizer to be deposited in the litter box. The plate apertures 46 allow the deodorizer to exit the dispensing plate 44 and be deposited along a bottom surface of the litter box. In some embodiments the dispensing plate 44 is rotated via a motor 86; as the dispensing plate 44 rotates centrifugal force pushes the deodorizer out the plate apertures 46.

For example, in operation the raking prongs 114 extend partially into the floor apertures 100 of the storage cavity 72. When the dispensing plate 44 rotates the raking prongs 114 disturb the deodorizer in the storage cavity 72 causing the material to fall through the floor apertures 100. The deodorizer then lands on the upper surface of the dispensing plate 44. As the dispensing plate 44 continues to rotate, centrifugal force pushes the deodorizer to the dispensing wall 120. Then, deodorizer that is pushed towards the cutouts 110 and plate apertures 46, is then distributed (via the centrifugal force) out of the plate apertures 46. Thus, as the dispensing plate 44 continues to rotate, deodorizer may be distributed along portions of the rotation path.

In some embodiments, when the dispensing plate 44 is not activated (e.g., not rotating) the cutouts 110 may be sealed. For example, the filter opening sidewalls 33 may block the cutouts 110, thus preventing deodorizer from being dispensed. When the dispensing plate 44 is activated and rotates, the cutouts 110 may rotate away from the opening sidewalls, creating the plate apertures 46. In other embodiments, the cutouts 110 may be blocked when the dispensing plate 44 is idle, similarly, the cutouts 110 then become un-blocked when the dispensing plate 44 rotates. In these embodiments, the neck 70 and/or the filter opening sidewalls 33 may include corresponding cutouts and/or apertures, these apertures may then align with cutouts 110 to form the plate apertures 46.

In some embodiments, the sensor 42 determines whether an animal is present in the litter box 10 and/or when the animal exits the litter box 10. After the animal exits the litter box, the sensor 42 sends a signal to the circuit board 84, which then activates the motor 86. The motor 86 then rotates the dispensing plate 44, dispensing the deodorizer stored in the storage cavity 72 into the litter box 10. In some embodiments, the dispensing plate 44 may rotate 360° allowing the deodorizer to adequately cover substantially the entire bottom surface of the litter box 10. Furthermore, because the dispensing plate 44 is rotating while dispensing the deodorizer, the deodorizer may be deposited substantially evenly along the bottom surface of the litter box 10 or in an arc covering a portion of the bottom interior surface. Also, the amount of deodorizer dispensed may be predetermined or may vary. For example, in some embodiments the dispensing plate 44 may rotate one complete cycle and every fifth rotation rotate twice to deposit a thicker layer of deodorizer. The dispensing amount and number of rotations may be set to any other desired variation and/or combinations. It should be noted, that in some embodiments the sensor 46 may not be located on the automatic filter, but on or within the litter box 10 and be in communication with the motor 86 and/or dispensing plate 44.

In other embodiments, the automatic filter 40, 60, 140 may be activated via user input. For example, the control buttons 50 may be used to activate the filter 40, 60. These controls may be used in replace of or in addition to the sensor 42. In these embodiments, in response to user input the dispensing plate 44 may rotate and dispense deodorizer along the bottom floor of the litter box. In some embodiments the control buttons 50 may also be used to stop the dispensing plate 44 from rotating, change the speed of rotation for the dispensing plate 44, or the like.

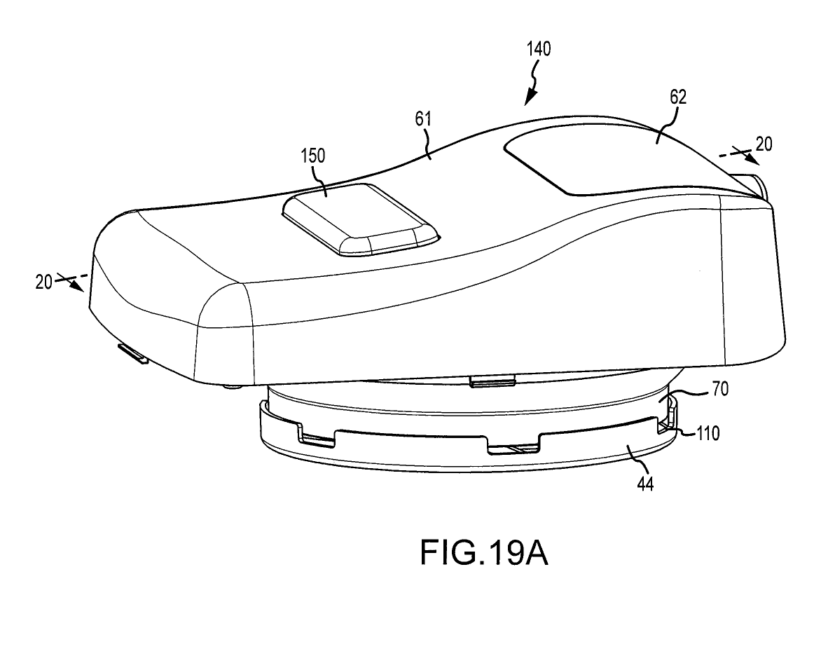

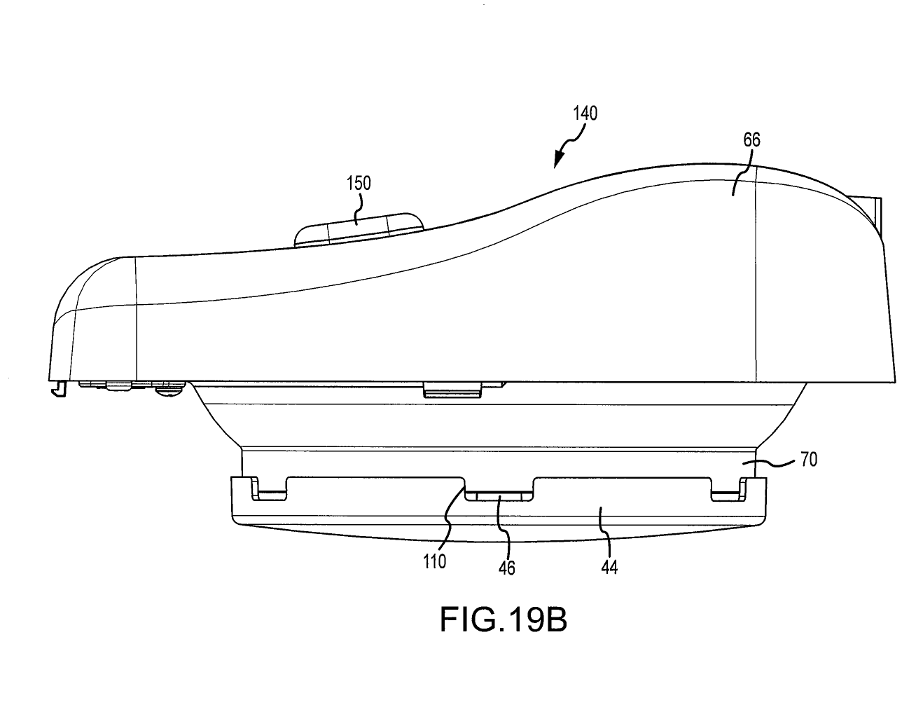

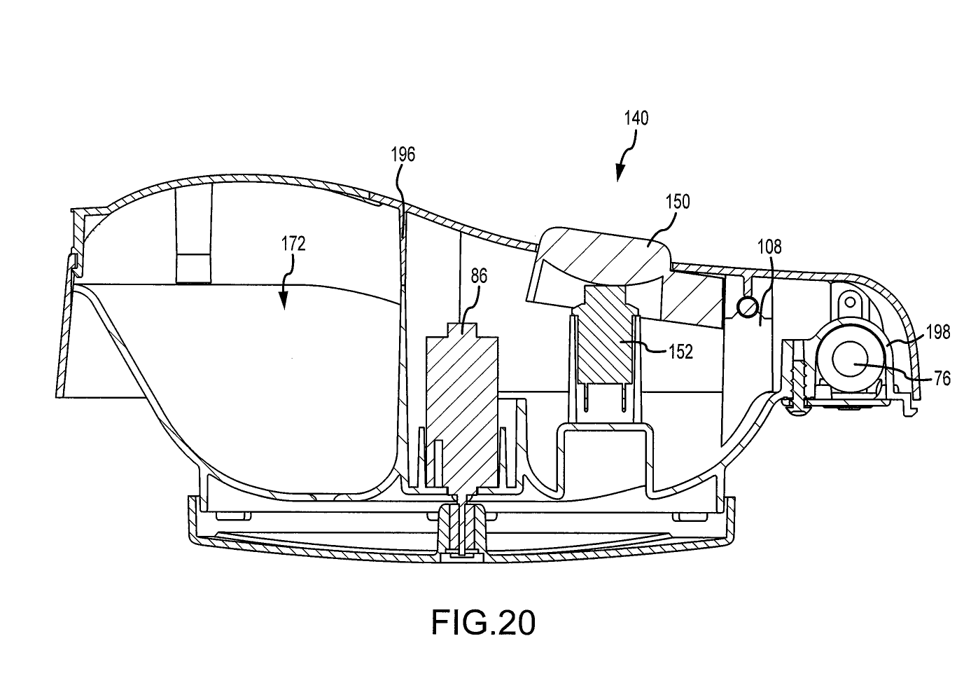

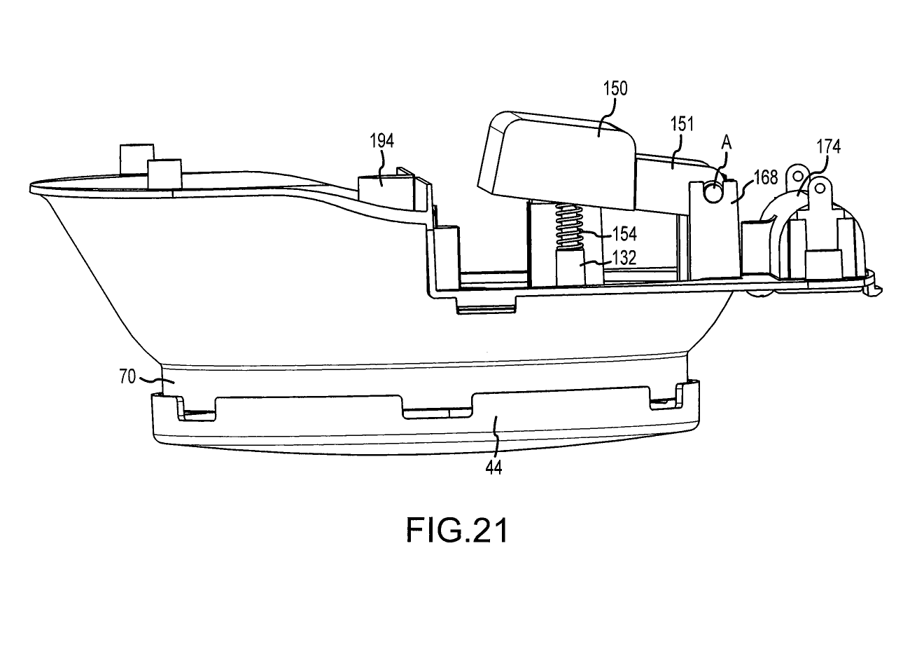

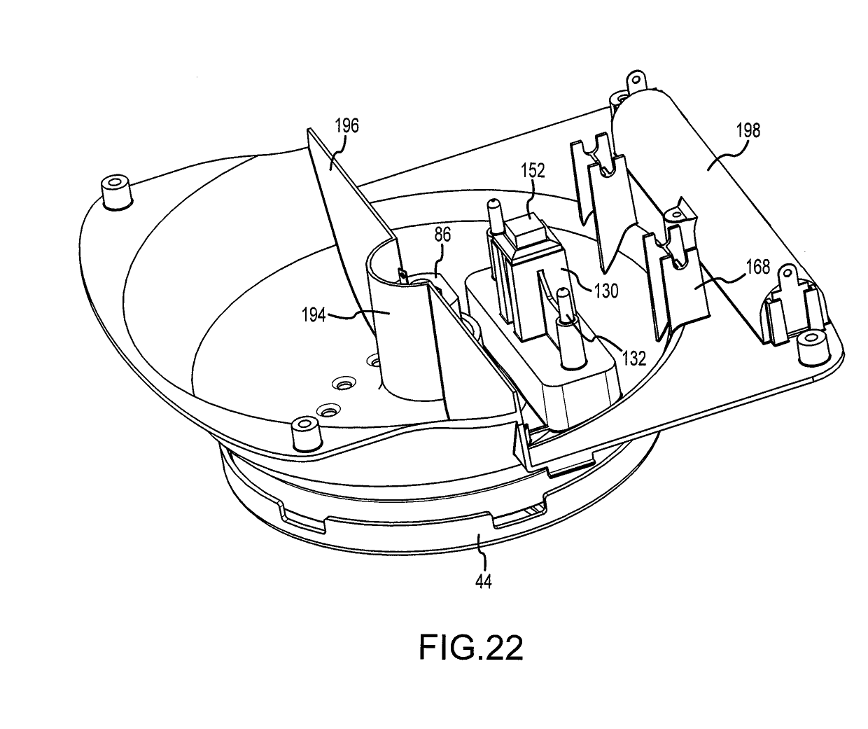

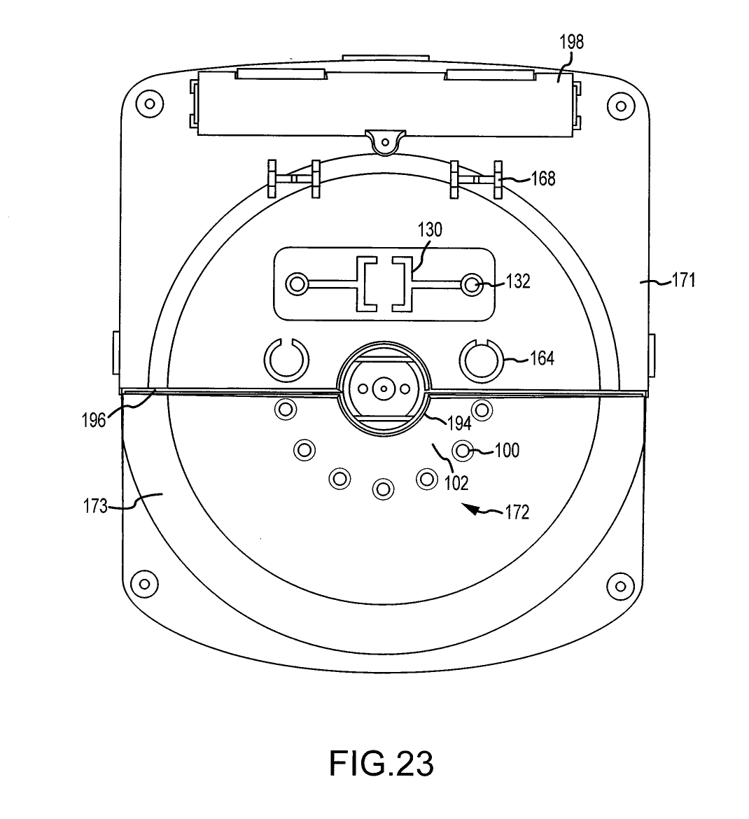

FIG. 19A is a perspective view of a third embodiment of the automatic filter 140, FIG. 19B is a side elevation view of the automatic filter 140, and FIG. 20 is a cross section view of the automatic filter 140 viewed along line 20-20 in FIG. 19A. FIG. 21 is an side elevation view of the automatic filter 140 with the case 161 remove, FIG. 22 is a top perspective view of the base 173 of the automatic filter, and FIG. 23 is a top plan view of the base 173. The automatic filter 140 may be substantially the same as the automatic filters 40, 60. However, in this embodiment, the automatic filter 140 may include a large control button 150 on the top surface of the casing 61. The size and location of the activation or control button 150 may make it easier for a user to activate the dispensing plate 44. Additionally, this embodiment may include an additional embodiment for the base 173.

The control button 150 may extend through the casing 61 into the interior space between the base 173 and the casing 61. The control button 150 may include a substantially rectangular body having a lever arm 151 extending from a back portion of the body. It should be noted that although the control button 150 is illustrated as a mechanical element, it may be an electrical switch, or the like. The lever arm 151 or hinge may be operably connected to the base 173, e.g., by arm supports 168. The lever arm 151 allows the control button 150 to flex downward when the button 150 is depressed, e.g., by rotating at a pivot point A. For example, the control button 150 may activate the motor 86 (rotating the dispensing plate 44) by electrically (or mechanically) connecting to the motor 86. For example, as the button 150 is depressed an electrical signal may be sent, a mechanical connection completing a circuit may be closed, or the like. In one embodiment, the control button 150 is operably connected to a switch 152. The switch 152 may be electrically or operably connected to the motor 86, e.g., the switch 152 may include prongs extending from a bottom surface. As the button 150 is depressed, the switch activates the motor 86, thus rotating the dispensing plate 44, e.g., the switch completes a circuit electrically connecting the batteries 76 to the motor 86.

The button 150 and the switch 152 may be supported on the base 173 via a button support 130, the arm support 168, and spring supports 132. The button support 130 extends from a rear portion of the base 173 behind the motor 86. the button support 130 substantially surrounds a portion of the switch 152 and the button 150 then rests on top of the switch 152. Two spring supports 132 are parallel to the button support 130. The spring supports are generally conical protrusions extending upward from the base 173. The spring supports 132 receive springs 154, and the springs 154 wrap around a portion of the spring supports 132. The springs 154 allow the button 150 to flex downward, activating the switch 152, and then bias the button 150 back upward to its original height above the top surface of the case 61.

Additionally, the base 173 may also include electrical supports 164 extending from an upper surface of the base 173. The electrical supports 164 may be C shaped support walls. The electrical supports 164 may be used to house an electrical circuit, connection, printed circuit board of the like. In other words, the electrical supports 164 may support a variety of electrical connections, for example, between the switch 152, the batteries 76, power cord, and the like. In other embodiments, the electrical supports 164 may house an additional motor (not shown). For example, a vibrating motor may be included in the automatic filter 140. In these embodiments the dispensing material may be additionally encouraged to flow through the floor apertures 100 within the base 173, e.g., the vibrating motor may shake the base 173, the floor 102 and/or the dispensing material.

The base 173 may include circular shaped floor apertures 100. The floor apertures 100 may be spaced in a circular shape around the bottom floor of the base 173. As with the floor apertures 100 in the other embodiments, the floor apertures 100 connect the dispensing plate 44 with the storage cavity 172.

The automatic filter 140 may also include an alternative embodiment for the battery cradle 198. In this embodiment, the batteries 76 may be aligned with one another in a straight line. Thus, the battery cradle 198 may be shaped as a rectangular housing and be configured to substantially support and cover the batteries 76. However, it should be noted that the battery cradle 98 may be varied depending on the power desired, the battery life desired, and the like.

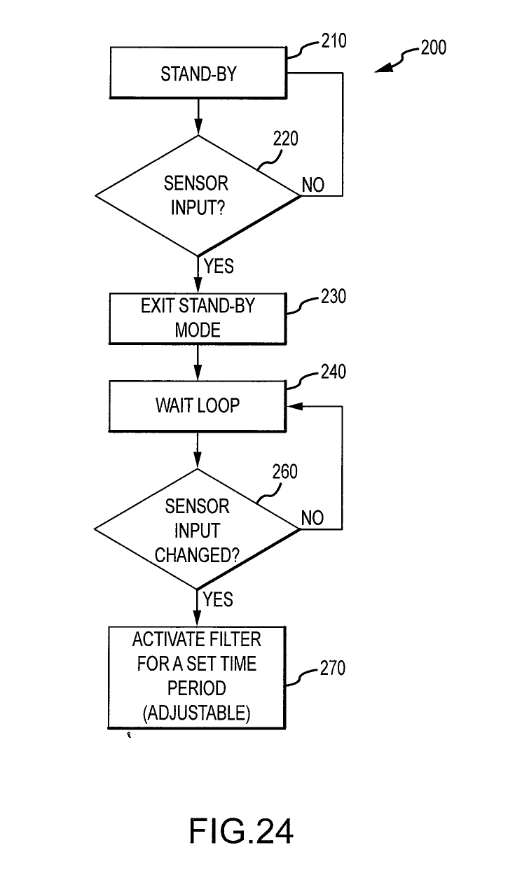

FIG. 24 illustrates a method 200 for an activation process for the automatic filters 40, 60, 140. Initially, the embodiment is in a stand-by mode 210. In operation 210 the automatic filter 40, 60, 140 is idle and is waiting for system input (e.g., manual activation, sensor signal, and the like). In operation 220, the embodiment determines if there is a sensor input. For example, the sensor may produce an input in response to an animal entering into the litter box 10. present within the litter box 10. This may be accomplished via the sensor 42, which may detect movement, heat, light or the like in order to determine if there is an animal present in the litter box 10. If an animal is detected, the embodiment proceeds to operation 230 and the automatic filter 40, 60, 140 exits stand-by mode. If no animal is detected, the method 200 remains in a stand-by mode as shown in operation 210.

In operation 230 the automatic filter 40, 60, 140 prepares to dispense the deodorizer. In some embodiments, the method 200 proceeds directly to operation 240 after operation 230. However, in some embodiments the automatic filter 40, 60, 140 may include a wait loop, an additional check, operations that verify if a signal from the sensor 42 has changed states or disappeared. These embodiments may prevent the deodorizer from being dispensed on top of the animal while it is in the litter box 10 and are generally represented by operation 260. For example, operation 260 may check to determine if the sensor's 42 input has changed. If, in operation 260, the sensor's 42 input has not changed, the method 200 may proceed back to operation 240 and the automatic filter 40, 60, 140 may enter a wait loop. However, if in operation 260, the sensor's 42 input has changed, the method 200 may proceed to operation 270. In operation 270, the automatic filter 40, 60, 140 is activated, e.g., the motor 86 may be powered on and rotate the dispensing plate 44, dispensing deodorizer inside the litter box 10.

As the automatic filter 40, 60, 140 may be set to be automatically activated after an animal has entered and exited the litter box 10, odors from the litter box 10 may be reduced more regularly. Additionally, some animals, such as cats, are nocturnal and frequently may use a litter box 10 more in the nighttime hours. In these instances, the automatic filter 40, 60, 140 may deposit the deodorizer regardless of the time of day or number of times the animal uses the litter box 10. This is beneficial as some animals may refused to use the litter box 10 if the litter box 10 is not clean or fresh smelling. As the deodorizer may help to disguise and/or eliminate odors, the animals may be more willing to use the litter box 10 in between cleanings by the owner.

However, it should be noted that in any of the embodiments of the automatic filter 40, 60, 140, the filter 40, 60, 140 may include a manual activation mechanism. For example, the automatic filter 40, 60, 140 may include the control button 50, 150. It should be noted that the control button 150, switches, or the like may be included either in addition to or instead of the sensor 46. For example, to decrease costs associated with the litter box 10, the sensor 46 may be omitted and the automatic filter 40, 60, 140 may be activated solely by the control button 150. In other embodiments, the control button 150 may provide the user the ability to further dispense deodorizer into the litter box 10, although the animal may not have used the litter box 10 recently.

In other embodiments, the litter box 10 may also include another electrical device, in addition to or in replace of the automatic filter 40, 60, 140. The electrical device may be coupled to a power source, such as a battery, a solar cell, any AC or DC power source, and so on and so forth. In some examples, the electrical device may be a light, fan, or any other electrical device. The device may be located inside the litter box housing 10 or outside the litter box housing 10. As one example, pressing on the filter housing 29 may activate the associated electrical device. As another example, a separate switch on the litter box 10 may activate a device located within the filter housing 29 and/or filter itself. In some embodiments, the switch may be coupled to a timer so that activation of the switch causes the electrical device (e.g., the light or fan) to run for a predetermined period of time after the switch is activated, or until the switch is toggled.

Forming the filter housing 29 as a separate piece from the litter box cover 34 may reduce manufacturing complexity and/or costs, as compared to manufacturing a litter box 10 including an integral litter box 10 receptacle. For example, the filter housing 29 and the litter box 10 may be manufactured in a two or three-step molding process. Generally, the litter box 10 is manufactured in a one or two-step molding process and the filter housing 29 is separately manufactured. Since the filter housing 29 is fully detachable from the litter box cover 34, manufacturing of an additional hinge, tab, or other component for attaching the filter housing 29 to the litter box 10 is not required. Additionally, these disclosed embodiments may further reduce the error associated with forming attachment mechanisms and/or cover plates, as these pieces often require precise manufacturing techniques.

Various changes and modifications may be made in carrying out the embodiments disclosed herein. Insofar as these changes and modifications are within the purview of the appended claims, they are to be considered as part of the disclosed embodiments. In this regard, it is to be understood that the particular configurations of the litter box cover and box are disclosed herein merely as examples of cover and litter box configurations which can be employed with the removable filter housing. Additionally, the embodiments disclosed herein include housing including separable litter box cover and litter box components, however, in other embodiments, the litter box housing may include a single container. Other litter box cover and box configurations could be employed.

What is claimed is:

1. A litter box comprising:
a base portion comprising:
a floor;
a plurality of walls extending in an upward direction from the floor;
a cover portion operably connected to the base portion, the cover portion comprising:
a ceiling;
a plurality of walls extending in a downward direction from the ceiling; and
a removable housing configured to receive an operating element;
wherein one of the cover portion and the base portion is configured to receive the removable housing.

2. The litter box of claim 1, wherein the operating element is a deodorizer dispenser.

3. The litter box of claim 2, wherein the deodorizer dispenser comprises
a motor operably connected to the removable housing;
a dispensing plate operably connected to the motor to the removable housing.

4. The litter box of claim 3, wherein the receiving portion includes an opening defined in the cover portion and the filter housing is slidingly received by the receiving portion by sliding the filter housing over the opening.

5. The litter box of claim 4, wherein the cover portion includes a receiving portion configured to receive the removable filter housing.

6. The litter box of claim 5, wherein the filter housing further includes one or more side surfaces, and at least one of the one or more side surfaces includes a guide rail.

7. The litter box of claim 6, wherein the receiving portion includes at least one or more receiving slots configured to receive the at least one of the one or more guide rails.

8. A method for activating an automatic filter operably connected to a litter box comprising:
receiving an input from a sensor when an animal enters the litter box;
initiating a wait loop;
activating the automatic filter, wherein activating the automatic filter comprises dispensing a deodorizer into the litter box.

9. The method of claim 8, further comprising verifying if input from the sensor has changed prior to activating the automatic filter.

10. The method of claim 8, wherein the automatic filter comprises
a filter cover;
a filter base operably connected to the filter cover;
a storage cavity configured to store the deodorizer, wherein the storage cavity is defined by the connection between the filter cover and the filter base;
a motor operably connected to the filter base; and
a dispensing plate operably connected to the storage cavity and in communication with the motor.

11. The method of claim 8, further comprising
receiving an input from a control button; and
activating the automatic filter.

12. A litter box comprising:
a body configured to receive a filter;
a filter operably connected to the body and configured to deposit a deodorizer onto an inner surface of the litter box, the filter comprising:
a filter cover;
a filter base operably connected to the filter cover;
a storage cavity configured to store the deodorizer and is defined by the connection between the filter cover and the filter base;
a motor operably connected to the filter base; and
a dispensing plate operably connected to the storage cavity and in communication with the motor.

13. The litter box of claim 12, wherein the filter further comprises a sensor in communication with the motor; and
wherein the sensor is configured to determine if there is an animal present within the litter box.

14. The litter box of claim 12, wherein the filter further comprises a control button operably connected to the filter base and the filter cover, and electrically connected to the motor; and
the control button is configured to selectively activate the motor.

15. The litter box of claim 12, wherein the deodorizer is sodium bicarbonate.

16. The litter box of claim 12, wherein the body further comprises:
a base portion comprising:
a floor; and
a plurality of walls extending in an upward direction from the floor;
a cover portion operably connected to the base portion, the cover portion comprising:
a ceiling; and
a plurality of walls extending in a downward direction from the ceiling; and wherein
the filter is operably connected to the cover portion.

17. The litter box of claim 12, wherein the dispensing plate comprises:
a plate cutout spaced along a sidewall forming a perimeter of the dispensing plate; and
a raking wall extending from a top surface of the dispensing plate having at least one raking prong configured to disturb the deodorizer when the deodorizer is stored in the storage cavity.

18. The litter box of claim 12, wherein the filter base further comprises a plurality of floor apertures in communication with the storage cavity.

19. The litter box of claim 12, further comprising a dividing wall operably connected to the filter base and substantially separating the storage cavity and the motor.

20. The litter box of claim 12, further comprising a power source operably connected to the filter and in electrical communication with the motor.
